(19) United States
(12) Patent Application Publication
(10) Pub. No.: US 2010/0031290 A1
(43) Pub. Date: Feb. 4, 2010

(54) METHOD AND APPARATUS FOR AUTOMATIC CHANNEL SWITCHING FOR IPTV

(75) Inventors: Suzann Hua, Lisle, IL (US); Ahmed Zaki, Lisle, IL (US)

Correspondence Address: FAY SHARPE/LUCENT, 1228 Euclid Avenue, 5th Floor, The Halle Building, Cleveland, OH, 44115-1843, US

(73) Assignee: LUCENT TECHNOLOGIES INC.

(21) Appl. No.: 12/182,388

(22) Filed: Jul. 30, 2008

(51) Int. Cl. H04N 5/445

(52) U.S. Cl. 725/39

(57) ABSTRACT

A method of providing automatic channel switching for IPTV is disclosed. The method includes: authenticating a user having an IPTV service profile upon receiving an indication that the user has powered on the user's IPTV viewing device; downloading the user's IPTV service profile from a subscriber database; retrieving the user's IPTV-related calendar data from a Calendar Server and storing the IPTV-related calendar data in a local database, wherein the calendar data includes the exact date and time at which the user wants to watch at least one IPTV broadcast on an IPTV viewing device; transmitting IPTV content to the user's IPTV viewing device through a set-top box; and changing the channel on the IPTV viewing device automatically based on the user's calendar data.

### BACKGROUND OF THE INVENTION

This invention relates to a method and apparatus for automatic IPTV channel switching. While the invention is particularly directed to the art of telecommunications, and will be thus described with specific reference thereto, it will be appreciated that the invention may have usefulness in other fields and applications.

By way of background, IPTV (Internet Protocol Television) is a system in which digital television service is delivered by using Internet Protocol over a network infrastructure, which may include delivery by a broadband connection. A general definition of IPTV is television content that, instead of being delivered through traditional broadcast and cable formats, is received by the viewer through the technologies used for computer networks.

For residential users, IPTV is often provided in conjunction with Video on Demand and may be bundled with Internet services such as Web access and VoIP. In businesses, IPTV may be used to deliver television content over corporate LANs.

IPTV covers both live TV (multicasting) as well as stored video (Video on Demand VOD). The playback of IPTV generally requires either a personal computer or a set-top box connected to a TV. Video content is typically compressed using either a MPEG-2 or a MPEG-4 codec and then sent in an MPEG transport stream delivered via IP Multicast in case of live TV or via IP Unicast in case of Video on Demand. IP Multicast is a method in which information can be sent to multiple computers at the same time.

There is a growing standardization effort on the use of the 3GPP IP Multimedia Subsystem (IMS) for supporting IPTV services in carrier networks. Both ITU-T and ETSI are working on so-called “IMS-based IPTV” standards (see, e.g., ETSI TS 182 027).

Currently an IPTV user's television will not change channels unless the user explicitly changes the channel with an IPTV control device. The user may have planned to view certain channels but may not always remember the plan. For example, a user may have planned to view a figure skating program on a certain channel at a certain time during the week but may have forgotten this plan later. Thus, there is a need for an Automatic Channel Switching function that will help the user to schedule channel selection and automatically switch the channel when the TV is powered on.

The present invention contemplates a new and improved method and apparatus that resolves the above-referenced difficulties and others.

### SUMMARY OF THE INVENTION

In accordance with an aspect of the present invention, a method of providing automatic channel switching for IPTV is provided. The method includes: authenticating a user having an IPTV service profile upon receiving an indication that the user has powered on the user's IPTV viewing device; downloading the user's IPTV service profile from a subscriber database; retrieving the user's IPTV-related calendar data from a Calendar Server after the IMS registration and storing the user's IPTV-related calendar data in a local database, wherein the calendar data includes the exact date and time at which the user wants to watch at least one IPTV broadcast on an IPTV viewing device; transmitting IPTV content to the user's IPTV viewing device through a set-top box; and changing the channel on the IPTV viewing device automatically based on the user's calendar data.

In accordance with another aspect of the present invention, an apparatus for providing automatic channel switching for IPTV is provided. The apparatus comprises: a subscriber database and an IPTV application server. The IPTV application server is operative to: authenticate a user having an IPTV service profile upon receiving an indication that the user has powered on the user's IPTV viewing device; download the user's IPTV service profile from a subscriber database; retrieve the user's IPTV-related calendar data from a Calendar Server and store the user's IPTV-related calendar data in a local database, wherein the calendar data includes the exact date and time at which the user wants to watch at least one IPTV broadcast on an IPTV viewing device; transmit IPTV content to the user's IPTV viewing device through a set-top box; and change the channel on the IPTV viewing device automatically based on the user's calendar data.

In accordance with yet another aspect of the present invention, a system for providing automatic channel switching for IPTV is provided. The system comprises: authenticating means for authenticating a user having an IPTV service profile upon receiving an indication that the user has powered on the user's IPTV viewing device; downloading means for downloading the user's IPTV service profile from a subscriber database; retrieving means for retrieving the user's IPTV-related calendar data from a Calendar Server; storing means for storing the calendar data, wherein the calendar data includes the exact date and time at which the user wants to watch at least one IPTV broadcast on an IPTV viewing device; transmitting means for transmitting IPTV content to the user's IPTV viewing device through a set-top box; and changing means for changing the channel on the IPTV viewing device automatically based on the user's calendar data.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a diagram of an IPTV architecture suitable for implementing aspects of the present invention;

FIG. 2 is a memory layout of data stored in the HSS for IPTV subscribers in accordance with aspects of the present invention;

FIG. 3 is a memory layout of data stored in a local database for IPTV subscribers in accordance with aspects of the present invention;

FIG. 4 is a flowchart illustrating an exemplary method of providing automated channel switching functions for IPTV subscribers; and

FIG. 5 is a call flow in accordance with aspects of the present invention.

### DETAILED DESCRIPTION

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a flash drive or a hard drive) or optical (e.g., a DVD), and may be read only or random access. Similarly, the transmission medium may be twisted wire pairs, coaxial cable, optical fiber, or some other suitable transmission medium known to the art. The invention is not limited by these aspects of any given implementation.

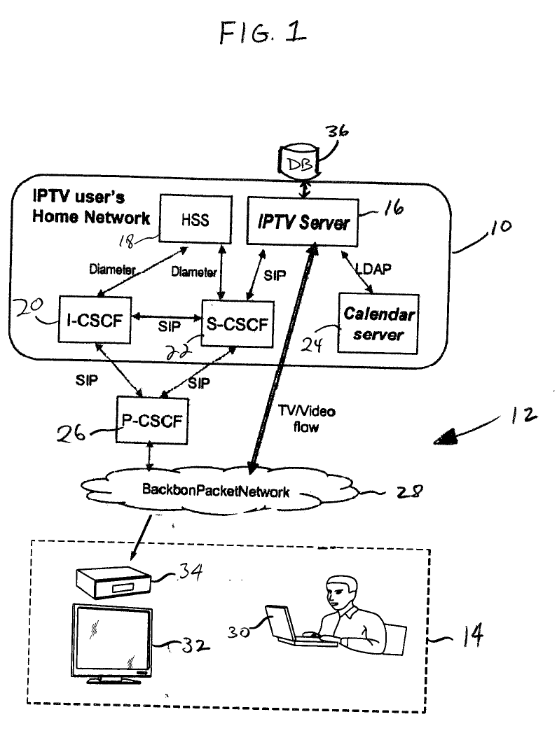

Referring now to the drawings wherein the showings are for purposes of illustrating the exemplary embodiments only and not for purposes of limiting the claimed subject matter, FIG. 1 provides a view of an IPTV network architecture into which the presently described embodiments may be incorporated. The major functional components of the IPTV network architecture include an IPTV user's Home Network 10, an IPTV distribution network 12, and a home viewing network 14.

The IPTV user's Home Network includes a number of network elements, including, but not limited to, an IPTV AS (application server) 16, an HSS 18, an I-CSCF 20, an S-CSCF 22, and a Calendar Server 24.

The IPTV AS 16 receives IPTV streams from an IPTV content source (not shown) and broadcasts within the home viewing network 14 the IPTV streams associated with television broadcasts, pay-per view broadcasts, Internet video broadcasts, and the like. The maximum number of available IPTV streams is bounded by the IPTV AS 16 capabilities or the maximum bandwidth capabilities of the home viewing network 14.

The IPTV AS 16 generally includes a CPU (not shown) such as a microprocessor or a secure server and is in communication with a subscriber database for storing pertinent information relating to the subscriber's IPTV service. The database may be the Home Subscriber Server (HSS) 18, or a special dedicated database for IPTV service. An HSS is a master user/subscriber database that supports the IMS network entities that actually handles calls. It contains the subscription-related information (user profiles), performs authentication and authorization of the user, and can provide information about the user's physical location.

The I-CSCF (Interrogating Call Session Control Function) 20 is an IMS (IP Multimedia Subsystem) element that provides a contact point within an operator's network and allows subscribers of the network operator, or roaming subscribers, to register. The I-CSCF 20 deals with registration, routing and forwarding of SIP messages and charging.

The S-CSCF (Serving Call Session Control Function) 22 is an IMS element that provides the session control services for a communication device and enables the network operator to support the services. Functions include: the management of mobile registrations, maintaining of the session, interaction with other services, and charging and security.

The user should have access to a network-based calendar server 24, such as one featuring Microsoft Outlook calendar. The user needs to indicate in the calendar specific information as to the program(s) the user wants to watch. Such information may include, for example, the name of the program, the channel the program is on, the time the program is to be broadcast, etc.

The IPTV distribution network 14 includes a number of network elements, including, but not limited to, a P-CSCF 26 and a backbone Packet Network 28. The distribution network 14 provides the distribution capability, capacity, quality of service and other capabilities, such as multicast, necessary for the reliable and timely distribution of IPTV data streams from the IPTV AS 16 to the home viewing network 14.

The P-CSCF (Proxy Call Session Control Function) 26 is an IMS element that identified as the mobiles first contact point within the IP Multimedia Core Network subsystem. Functions of the P-CSCF 26 include the forwarding of SIP messages received from the user equipment. These may be sent to the I-CSCF 20 or the S-CSCF 22, depending on the type of message and procedure being carried out.

The home viewing network 14 generally includes one or more Web-based communication devices 30 and one or more IPTV viewing devices 32. Each IPTV viewing device 32 may have a corresponding Set-Top Box (STB) 34.

The components of the home viewing network 14 may be arranged in any desired fashion. The IPTV AS 16 interfaces with the home viewing network 14 via the distribution network 12, which is typically a SIP-based system. SIP (Session Initiation Protocol) is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer; it can run on TCP, UDP, or SCTP. The latest version of the specification is RFC 3261 from the IETF SIP Working Group. It is widely used as a signaling protocol for Voice over IP, along with H.323 and others.

The home viewing network 14 may be wired, wireless, or a combination of wired and wireless. It is also noted that although the term “home” is used in connection with the phrase “home viewing network” that the network is not limited to a residential home or dwelling. That is, any local area network within a defined area viewing area accessible to a single account with an IPTV provider may be viewed as a home viewing network.

Customer delivery of IPTV is generally provided over the existing loop plant and the phone lines to homes using the higher-speed DSL technologies such as ADSL2+ and VDSL. Service providers may use a combination of Fiber-to-the Curb (FTTC) and DSL technologies or implement direct Fiber-to-the-Home (FTTH) access depending on the richness of their IPTV service offerings.

Each communication device 30 generally comprises a computer (desktop or laptop), a PDA, or a wireless phone that can connect to the Internet and log in to the Web-based Calendar Server 24.

The IPTV viewing device 32 is a standard-definition or high definition television or a monitor that permits video or television broadcasts to be viewed thereon. The set-top box 34 is the functional unit that terminates the IPTV traffic at the home viewing network 14. This device performs the functional processing, which includes setting up the connection and QoS (Quality of Service) with the Service Node, decoding the video streams, channel change functionality, user display control, and connections to user appliances such as a standard-definition TV or HDTV monitor. Each STB will be assigned with IMS Private and Public User IDs.

In some cases, the STB (Digital Versatile Recorder (DVR), etc.) 34 may be viewed as a remote viewing device, if that STB includes the processing instructions associated with directly interfacing with the distribution network 12. Moreover, each remote viewing device directly interfaces with a viewing device that is capable of presenting the IPTV streams of the home viewing network. Also, in some cases where the remote viewing device is not a STB, a remote viewing device may be directly interfaced with that STB.

The HSS 18 will treat each user's TV terminal as an IMS subscriber and store the corresponding IMS IDs and related service profiles. The HSS 18 also stores Initial Filter Criteria (IFC) to contact the IPTV server 16 upon the IPTV terminal's SIP REGISTER. The IFC will include ServiceInfo data that indicates the user has subscribed to integrated ACS service with IPTV.

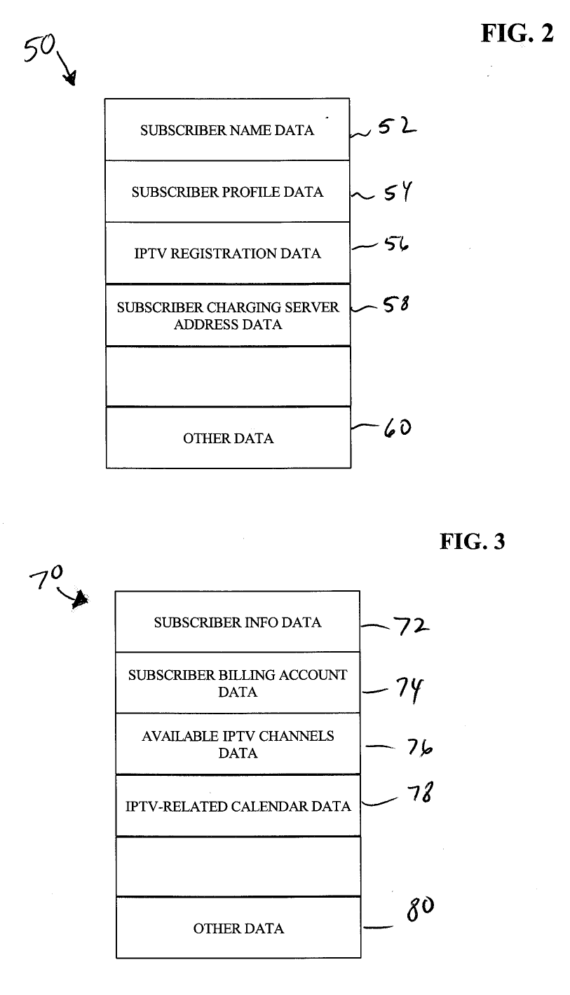

Thus, the HSS 18 generally includes any number of data sub-blocks for each subscriber having IPTV service, as shown in FIG. 2. They are shown as a super block 50, not all of whose fields are filled for a particular subscriber. The super block 50, as known in the art, can be accessed from the identity of any one of several fields within it. The super block 50 includes any number of data sub-blocks, including a first sub-block 52 that contains subscriber name data, a second sub-block 54 that contains subscriber profile data including Initial Filter Criteria data, a third sub-block 56 that contains IPTV registration data, a fourth sub-block 58 that contains subscriber charging server address data. Of course, any number of additional sub-blocks may be provided in the super block 50.

The IPTV server 16 may also have a local database 36 that contains additional subscriber data, as shown in FIG. 3. They are shown as a super block 70, which includes any number of data sub-blocks, including a first sub-block 72 that contains subscriber info data, a second sub-block 74 that contains billing account data, a third sub-block 76 that contains available IPTV channels data (or level of service data), and a fourth sub-block 78 that contains IPTV-related calendar data downloaded from the user's calendar server upon the user's IPTV device being powered on (or IMS registration). Of course, any number of additional sub-blocks may be provided in the super block 80.

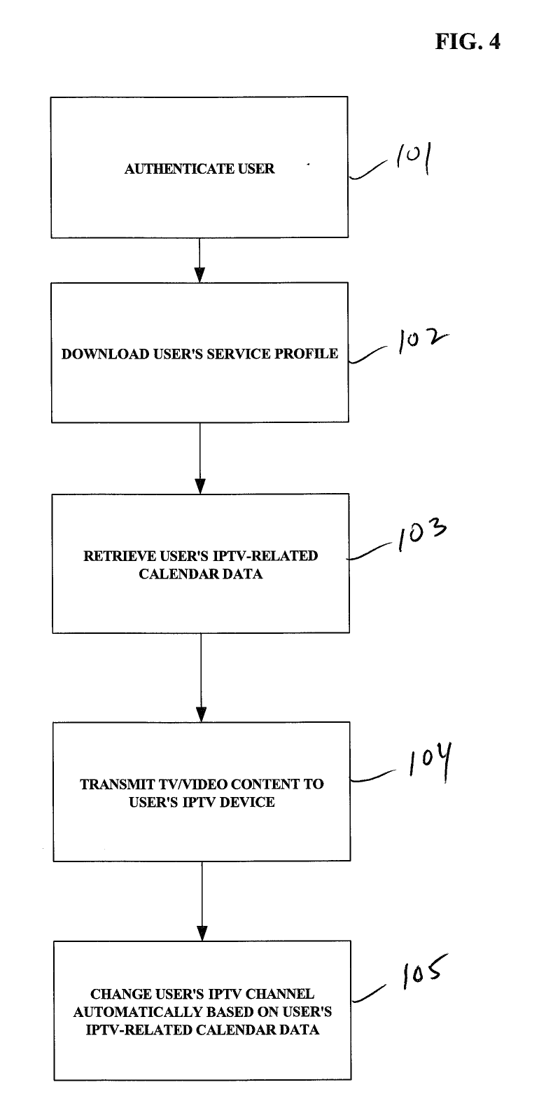

An exemplary method of providing Automatic Channel Switching (ACS) with IPTV is illustrated in FIG. 4. It may be assumed that the user has subscribed to ACS with their IPTV service provider and has updated their Web-based calendar on the Calendar Server 24 with their preferred program scheduling information. That is, the user has specified, on the Web-based calendar, the exact date(s) and time(s) at which they wish to watch one or more television programs.

Thus, when the user powers on the IPTV viewing device 32 (and the corresponding STB 34), the network 10 will authenticate the user (101). Once the user has been authenticated, the user's IPTV service profile will be downloaded from a database such as the HSS 18 (102). Next, the user's IPTV-related calendar data (i.e., the preferred program scheduling information) will be retrieved from the Calendar Server 24 and stored in the local database 36 (103). TV/Video content will then be transmitted by the IPTV Server 16 to the IPTV viewing device 32, generally through the STB 34 (104). Now, the channel may be changed automatically based on the user's IPTV-related calendar data (105).

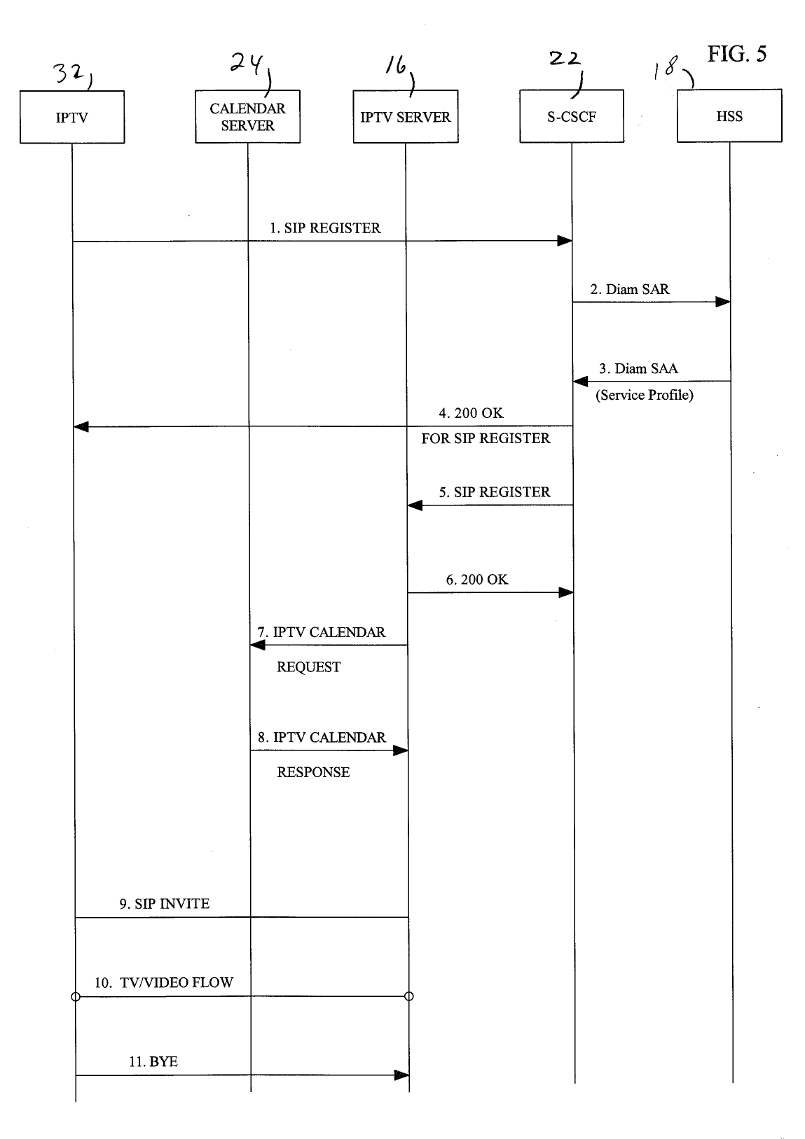

To help illustrate an implementation of the method described above, we turn now to FIG. 5, which shows an exemplary call flow. As shown in FIG. 5:

1. When a user's viewing device 32 is powered on, it will send a SIP REGISTER message to the S-CSCF 22 through the STB 34.

2. The S-CSCF 22 then contacts the HSS 18 for user authentication.

3. After the authentication process is complete, the S-CSCF 22 will download the user's service profile, which includes the Initial Filter Criteria, that is, contact the IPTV server 16 where the user has subscribed to integrated ACS service with the IPTV service provider.

4. The S-CSCF 22 responds to the user's viewing device 32 (through the STB 34) with a 200 OK message.

5. The user's service profile's IPTV Initial Filter Criteria triggers the S-CSCF 22 to forward the SIP REGISTER message to the IPTV server 16 as a third party REGISTER, which carries ServiceInfo data indicating that the user has integrated ACS service with IPTV.

6. The IPTV server 16 responds with a 200 OK message.

7. The IPTV server 16 then requests the user's current calendar data from the network calendar server 24 via a database protocol such as LDAP or ODBC.

8. The user's calendar data is sent to the IPTV server 16, which stores the calendar data in the local database 36. The calendar data will list, for example, when and what channels should be played on the viewing device 32. At the time as scheduled in the user's calendar, the IPTV server 16 may retrieve the downloaded calendar data from the local database 36 or receive a reminder from the network-based calendar server 24 directly and then automatically switch/change the channel for the user at the specified time if the IPTV viewing device 32 (and STB 34) is powered on.

9. After the IPTV 32 receives the REGISTER success response from the S-CSCF 22, it initiates a SIP INVITE with the IPTV server 16 as the destination indicated with INVITEs to the header.

10. Once the communication session is setup, the point to point video flow can be transmitted between the IPTV terminal 32 and the IPTV server 16. Based on the retrieved user's calendar data, the IPTV server 16 can switch the channel on the user's IPTV viewing device 32. During the TV/Video session, when the IPTV server 16 receives a user's channel schedule reminder, the IPTV server 16 will automatically change the channel and deliver the changed channel content to user's IPTV viewing device 32. The IPTV server 16 may either receive the reminder directly from network calendar server or receive the reminder locally based user's calendar info stored in IPTV server 16 that is retrieved during the IPTV's registration. The IPTV server 16 may also include a notice to the user through the IPTV viewing device 32, such as “you have scheduled to watch channel xxx at the time xx.”

11. When the IPTV viewing device 32 and/or the STB 34 is powered off, the communication session ends.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of providing automatic channel switching for IPTV, the method comprising:
authenticating a user having an IPTV service profile upon receiving an indication that the user has powered on the user's IPTV viewing device;
downloading the user's IPTV service profile from a subscriber database;
retrieving the user's IPTV-related calendar data from a Calendar Server and storing the user's IPTV-related calendar data in a local database, wherein the calendar data includes the exact date and time at which the user wants to watch at least one IPTV broadcast on an IPTV viewing device;
transmitting IPTV content to the user's IPTV viewing device through a set-top box; and
changing the channel on the IPTV viewing device automatically based on the user's calendar data.

2. The method of claim 1, wherein the subscriber database stores one or more of the following types of data: subscriber name data, subscriber profile data, IPTV registration data, subscriber charging server address data, and Initial Filter Criteria, wherein the Initial Filter Criteria indicates whether the user has subscribed to integrated Automatic Channel Switching service for IPTV.

3. The method of claim 1, wherein the local database stores one or more of the following types of data: subscriber info data, subscriber billing account data, available IPTV channels data, and PTV-related calendar data.

4. The method of claim 1, wherein the database comprises a Home Subscriber Server (HSS).

5. The method of claim 1, wherein the IPTV application server interfaces with the user's IPTV viewing device via a SIP-based distribution network.

6. The method of claim 1, wherein the user's IPTV service profile includes Initial Filter Criteria that indicates the user has subscribed to Automatic Channel Switching Service for IPTV.

7. The method of claim 1, further comprising: at the time as scheduled in the user's calendar, retrieving the downloaded calendar data from the local database or receiving a reminder from the Calendar Server directly.

8. An apparatus for providing automatic channel switching for IPTV, the apparatus comprising:
a subscriber database; and
an IPTV application server operative to:
authenticate a user having an IPTV service profile upon receiving an indication that the user has powered on the user's IPTV viewing device;
download the user's IPTV service profile from a subscriber database;
retrieve the user's IPTV-related calendar data from a Calendar Server and store the user's IPTV-related calendar data in a local database, wherein the calendar data includes the exact date and time at which the user wants to watch at least one IPTV broadcast on an IPTV viewing device;
transmit IPTV content to the user's IPTV viewing device through a set-top box; and
change the channel on the IPTV viewing device automatically based on the user's calendar data.

9. The apparatus of claim 8, wherein the database stores one or more of the following types of data: subscriber name data, subscriber profile data, IPTV registration data, subscriber subscriber charging server address data, IPTV channels data, and Initial Filter Criteria, wherein the Initial Filter Criteria indicates whether the user has subscribed to integrated Automatic Channel Switching service for IPTV.

10. The apparatus of claim 8, wherein the local database stores one or more of the following types of data: subscriber info data, subscriber billing account data, available IPTV channels data, and PTV-related calendar data.

11. The apparatus of claim 8, wherein the database comprises a Home Subscriber Server (HSS).

12. The apparatus of claim 8, wherein the IPTV application server interfaces with the user's IPTV viewing device via a SIP-based distribution network.

13. The apparatus of claim 8, wherein the user's IPTV service profile includes Initial Filter Criteria that indicates the user has subscribed to Automatic Channel Switching Service for IPTV.

14. A system for providing automatic channel switching for IPTV, the system comprising:
authenticating means for authenticating a user having an IPTV service profile upon receiving an indication that the user has powered on the user's IPTV viewing device;
downloading means for downloading the user's IPTV service profile from a subscriber database;
retrieving means for retrieving the user's IPTV-related calendar data from a Calendar Server;
storing means for storing the user's IPTV-related calendar data, wherein the calendar data includes the exact date and time at which the user wants to watch at least one IPTV broadcast on an IPTV viewing device;
transmitting means for transmitting IPTV content to the user's IPTV viewing device through a set-top box; and
changing means for changing the channel on the IPTV viewing device automatically based on the user's calendar data.

15. The system of claim 14, wherein the database stores one or more of the following types of data: subscriber name data, subscriber profile data, IPTV registration data, subscriber charging server address data, IPTV channels data, and Initial Filter Criteria, wherein the Initial Filter Criteria indicates whether the user has subscribed to integrated Automatic Channel Switching service for IPTV.

16. The system of claim 14, wherein the local database stores one or more of the following types of data: subscriber info data, subscriber billing account data, available IPTV channels data, and PTV-related calendar data.

17. The system of claim 14, wherein the database comprises a Home Subscriber Server (HSS).

18. The system of claim 14, wherein the IPTV application server interfaces with the user's IPTV viewing device via a SIP-based distribution network.

19. The system of claim 14, wherein the user's IPTV service profile includes Initial Filter Criteria that indicates the user has subscribed to Automatic Channel Switching Service for IPTV.
